(19) United States
(12) Patent Application Publication
(10) Pub. No.: US 2021/0242499 A1
(43) Pub. Date: Aug. 5, 2021

(54) NON-AQUEOUS ELECTROLYTE POWER STORAGE DEVICE AND METHOD FOR MANUFACTURING NON-AQUEOUS ELECTROLYTIC POWER STORAGE DEVICE

(71) Applicant: TOYOTA JIDOSHA KABUSHIKI KAISHA, Toyota-shi (JP)

(72) Inventors: Kento HOSOE, Miyoshi-shi (JP); Shinsuke MATSUHARA, Miyoshi-shi (JP)

(21) Appl. No.: 17/098,755

(22) Filed: Nov. 16, 2020

(30) Foreign Application Priority Data
Jan. 31, 2020 (JP) 2020-015662

(51) Int. Cl. H01M 10/0568; H01M 4/04

(52) U.S. Cl. CPC H01M 10/0568; H01M 4/0416

(57) ABSTRACT

A method for manufacturing a non-aqueous electrolytic power storage device includes preparing a mixture paste in which an active material particle, a binder, and carboxymethylcellulose are mixed in an aqueous solvent, applying the mixture paste to a current collector, and drying the applied mixture paste. Here, a proportion of carboxymethylcellulose having an etherification degree of 40 mol/C6 or less is 0.5 wt % or more in terms of a solid content fraction in the mixture paste.

### CROSS-REFERENCE TO RELATED APPLICATION

This application claims priority to Japanese Patent Application No. 2020-015662 filed on Jan. 31, 2020, incorporated herein by reference in its entirety.

### BACKGROUND

### 1. Technical Field

The disclosure relates to a non-aqueous electrolytic power storage device and a method for manufacturing the non-aqueous electrolytic power storage device.

### 2. Description of Related Art

Japanese Patent No.3444616 (JP 3444616 B) discloses a negative electrode for a non-aqueous secondary battery. The negative electrode for the non-aqueous secondary battery disclosed herein is composed of carbonaceous material particles, a mixture of less than 20% by weight with respect to the carbonaceous material particles, and a current collector. In the negative electrode for the non-aqueous secondary battery, the carbonaceous material particles consist of graphite particles having a surface spacing d₀₀₂ of a carbon network surface of less than 0.337 nm or other carbonaceous materials of 50% by weight or less with the graphite particles. The negative electrode for a non-aqueous secondary battery is characterized by a porosity of 10% to 60% and the volume of a pore in the range of 0.1 to 10 μm in diameter occupying 80% or more of the total pore volume.

Japanese Unexamined Patent Application Publication No. 2006-59690 (JP 2006-59690 A) discloses a negative electrode of a non-aqueous electrolyte secondary battery. The negative electrode disclosed herein has a pore volume of 0.15 cc/g to 0.35 cc/g with a pore diameter of 10 μm or less. Further, an increased volume pore distribution has a peak at a pore diameter of 0.4 to 3.5 μm. Furthermore, the slope of the cumulative pore distribution curve in the range of pore diameters from 0.001 μm to 10 μm at the cumulative 40% to 60% is in the range of 1.5 to 4.5. It is said that the non-aqueous electrolyte secondary battery including the above-described negative electrode has improved charge and discharge cycle life.

### SUMMARY

By the way, an aspect of the disclosure relates to a non-aqueous electrolytic power storage device, and has a structure in which Li easily diffuses into an active material layer in order to reduce the resistance.

A method for manufacturing a non-aqueous electrolytic power storage device according to a first aspect of the disclosure, the method including preparing a mixture paste, and applying and drying the mixture paste. The mixture paste is prepared by mixing the active material particle, the binder, and carboxymethylcellulose in the aqueous solvent. The mixture paste is applied to the current collector. The applied mixture paste is dried. Here, a proportion of carboxymethylcellulose having an etherification degree of 40 mol/C6 or less is 0.5 wt % or more in terms of a solid content fraction in the mixture paste. In this case, the manufactured non-aqueous electrolyte secondary battery has an active material layer having a structure in which Li easily diffuses, so that the resistance can be reduced.

The proportion of carboxymethylcellulose having the etherification degree of 40 mol/C6 or less may be 15 wt % or less in terms of the solid content fraction in the mixture paste.

The preparing of the mixture paste may include preparing the mixture paste in which the active material particle and the binder are mixed in the aqueous solvent, and then mixing carboxymethylcellulose having the etherification degree of 40 mol/C6 or less into the mixture paste.

The non-aqueous electrolytic power storage device according to the second aspect of the disclosure includes an active material layer that contains carboxymethylcellulose having an etherification degree of 40 mol/C6 or less and has pores of 4 μm or more and 106 μm or less per unit area, the pores having 25% or more of a total pore volume. Therefore, Li easily diffuses, and the resistance can be reduced.

The proportion of carboxymethylcellulose having the etherification degree of 40 mol/C6 or less, contained in the active material layer may be, for example, 0.5 wt % or more. The proportion of carboxymethylcellulose having the etherification degree of 40 mol/C6 or less, contained in the active material layer may be, for example, 2 wt % or less. The proportion of carboxymethylcellulose having the etherification degree of 40 mol/C6 or less in the carboxymethylcellulose contained in the active material layer may be 50% or more.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view showing a configuration of a lithium ion secondary battery;

FIG. 2 is a partially developed view showing a configuration of an electrode body;

FIG. 3 is a process diagram schematically showing a step of producing an electrode sheet;

FIG. 4 is an SEM photograph of a surface of an active material layer;

FIG. 5 is an SEM photograph in which holes on a surface of an active material layer are enlarged;

FIG. 6 is a cross-sectional view schematically showing a current collector applied with a mixture paste;

FIG. 7 is a cross-sectional view schematically showing the current collector in a state where a mixture paste is dried;

FIG. 8 is a graph showing measurement results of mercury porosimeter of an active material layer; and

FIG. 9 is a graph showing measurement results of mercury porosimeter of an active material layer.

### DETAILED DESCRIPTION OF EMBODIMENTS

Hereinafter, an embodiment of a non-aqueous electrolytic power storage device and a method for manufacturing the non-aqueous electrolyte power storage device disclosed herein will be described. The embodiments described herein are, of course, not intended to specifically limit the disclosure. The disclosure is not limited to the embodiments described herein unless otherwise stated. In the present specification, a notation such as “X to Y” indicating a numerical range means “X or more and Y or less” unless otherwise stated.

In the present specification, the “non-aqueous electrolytic power storage device” is a power storage device using a non-aqueous electrolyte solution containing a charge carrier. The power storage device refers to a device that can be charged and discharged. The non-aqueous electrolytic power storage device includes a non-aqueous electrolyte secondary battery. The “non-aqueous electrolyte secondary battery” refers to a general battery that uses a non-aqueous electrolyte containing the charge carrier and can be repeatedly charged and discharged as the charge carrier moves between positive and negative electrodes. The non-aqueous electrolytic power storage devices include lithium polymer batteries, lithium ion capacitors, and the like, in addition to batteries generally called lithium-ion batteries and lithium secondary batteries. Hereinafter, the technology disclosed herein will be described by taking a lithium ion secondary battery 1 according to an embodiment of the non-aqueous electrolyte secondary battery as an example. It should be noted that the lithium ion secondary battery is exemplified here, but the non-aqueous electrolyte secondary battery is not limited to the lithium ion secondary battery.

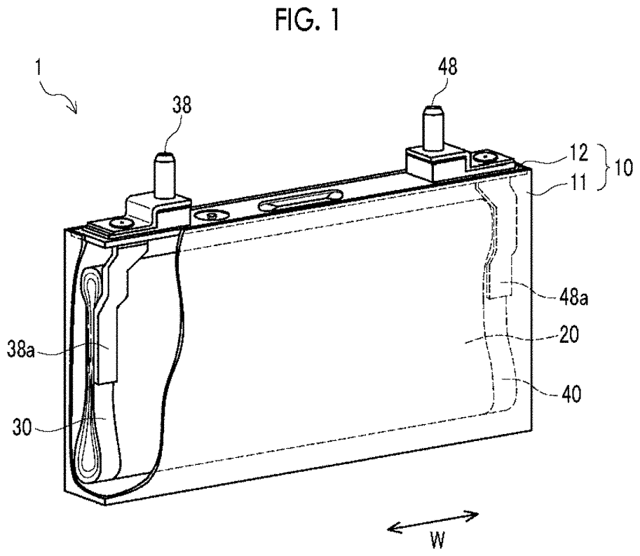

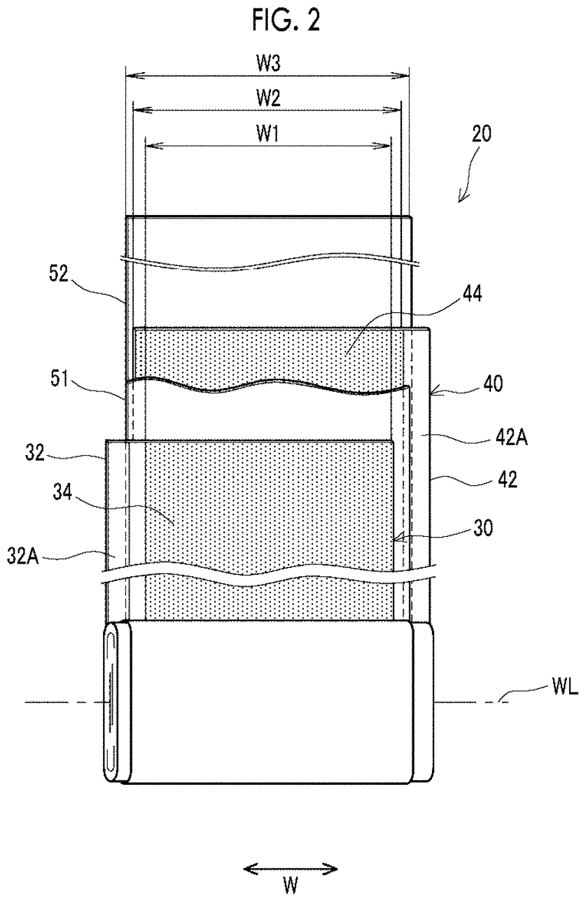

FIG. 1 is a perspective view showing a configuration of a lithium ion secondary battery 1. In FIG. 1, a part of a battery case 10 of the lithium ion secondary battery 1 is cut away, and an electrode body 20 inside the battery case 10 is shown in an exposed state. FIG. 2 is a partially developed view showing a configuration of an electrode body 20.

As shown in FIG. 1, the lithium ion secondary battery 1 accommodates the electrode body 20 and the non-aqueous electrolyte (not shown) in the battery case 10. The electrode body 20 is accommodated in the battery case 10 in a state of being covered with an insulating film (not shown). For example, as shown in FIG. 2, the electrode body 20 is a so-called wound electrode body in which a positive electrode sheet 30 and a negative electrode sheet 40 are superposed and wound with a long strip-shaped first separator sheet 51 or a long strip-shaped second separator sheet 52 interposed therebetween. It should be noted that as another aspect of the electrode body 20, a so-called laminated type electrode body in which the positive electrode sheet and the negative electrode sheet are superposed with a separator sheet interposed may be used. W in FIG. 1 indicates the width direction along the winding axis of the wound electrode body. This is a direction that coincides with a winding axis WL of the wound electrode body 20 shown in FIG. 2.

As shown in FIG. 2, the positive electrode sheet 30 includes a positive electrode current collector 32 and a positive electrode active material layer 34. The positive electrode current collector 32 is a member for holding the positive electrode active material layer 34 and supplying or collecting charges to the positive electrode active material layer 34. The positive electrode current collector 32 is suitably configured with a conductive member consisting of a metal (for example, aluminum, aluminum alloys, nickel, titanium, stainless steel, and the like) which is electrochemically stable in the positive electrode environment in the battery and has good conductivity. In the embodiment, the positive electrode current collector 32 is, for example, an aluminum foil, and an unformed portion 32A having a constant width is set at one end portion in the width direction. The positive electrode active material layer 34 is formed on both surfaces of the positive electrode current collector 32 except for the unformed portion 32A. Here, the unformed portion 32A can be a positive electrode current collector of the electrode body 20.

The positive electrode active material layer 34 is a porous body containing positive electrode active material particles. The positive electrode active material layer 34 can be impregnated with an electrolyte. In the lithium ion secondary battery, the positive electrode active material particles are materials capable of releasing lithium ions, which are charge carriers, at the time of charging and absorbing at the time of discharging, like a lithium transition metal composite material. The positive electrode active material layer 34 may additionally contain a conductive material and trilithium phosphate (Li₃PO₄; hereinafter simply referred to as “LPO”).

In the positive electrode active material layer 34, typically, a granular positive electrode active material is bonded together with a conductive material by a binder and is bonded to the positive electrode current collector 32.

As the positive electrode active material, various materials used in the related art as the positive electrode active material of the lithium ion secondary battery can be used without particular limitation. Suitable examples include particles of oxides (lithium transition metal oxide) containing lithium and transition metal elements as constituent metal elements, such as lithium nickel oxide (For example, LiNiO₂), lithium cobalt oxide (For example, LiCoO₂), lithium manganese oxide (for example, LiMn₂O₄), and complexes thereof (for example, LiNi_{0.5}Mn_{1.5}O₄, LiNi_{1/3}Co _{1/3}Mn_{1/3}O₂), and particles of phosphates containing lithium and transition metal elements as constituent metal elements, such as lithium manganese phosphate (LiMnPO₄) and lithium iron phosphate (LiFePO₄).

The positive electrode active material layer 34 can be produced, for example, by supplying a positive electrode paste to the surface of the positive electrode current collector 32 and then drying the positive electrode paste to remove a dispersion medium. The positive electrode paste is a mixture prepared by dispersing a positive electrode active material, a conductive material, and a binder in an appropriate dispersion medium. Here, as the binder, for example, an acrylic resin such as a (meta) acrylic ester polymer, a vinyl halide resin such as poly vinylidene difluoride (PVDF), or a polyalkylene oxide such as polyethylene oxide (PEO) are used. The dispersion medium is, for example, N-methyl-2-pyrrolidone. In the configuration including the conductive material, as the conductive material, for example, carbon materials such as carbon black (typically acetylene black and ketjen black), activated carbon, graphite, and carbon fiber are suitably used. Any one of the conductive materials may be used alone, or two or more thereof may be used in combination.

An average particle diameter (D50) of the positive electrode active material particles is not particularly limited. The average particle diameter (D50) of the positive electrode active material particles may be, for example, 1 μm or more, preferably 3 μm or more, for example, 5 μm or more. In addition, the average particle diameter (D50) of the positive electrode active material particles may be, for example, 15 μm or less, preferably 10 μm or less, for example 8 μm or less.

The proportion of the positive electrode active material to the whole positive electrode active material layer 34 may be about 75 mass % or more, typically 80 mass % or more, for example, 85 mass % or more, and typically 99 mass % or less, for example, 95 mass % or less. The proportion of the conductive material in the positive electrode active material layer 34 is typically 1 part by mass or more, preferably 3 parts by mass or more, for example, 5 parts by mass or more, and typically 15 parts by mass or less, preferably 12 parts by mass or less, for example, 10 parts by mass or less, with respect to 100 parts by mass of the positive electrode active material. The proportion of the binder in the positive electrode active material layer 34 is typically 0.5 parts by mass or more, preferably 1 part by mass or more, for example 1.5 parts by mass or more, and typically 10 parts by mass or less, preferably 8 parts by mass or less, for example 5 parts by mass or less, with respect to 100 parts by mass of the positive electrode active material.

The thickness of the positive electrode active material layer 34 after pressing (the thickness is an average thickness, and the same applies hereinafter.) is typically 10 μm or more, for example, 15 μm or more, and typically 50 μm or less, 30 μm or less, for example, 25 μm or less. In addition, the density of the positive electrode active material layer 34 is not particularly limited, but the density can be typically 1.5 g/cm³ or more, for example, 2 g/cm³ or more, and 3 g/cm³ or less, for example, 2.5 g/cm³ or less. The positive electrode active material layer 34 is a layer of positive electrode active material particles in which positive electrode active material particles are bonded with a binder. Microscopically, the positive electrode active material layer 34 has fine voids that can be impregnated with the non-aqueous electrolyte.

It should be noted that in the present specification, the “average particle diameter” is the cumulative 50% particle diameter (D50) in the volume-based particle size distribution obtained by a laser diffraction scattering method, unless otherwise specified. In addition, the particle diameter corresponding to cumulative 10% from the small particle diameter side in the particle size distribution is referred to as D10, the particle diameter corresponding to cumulative 90% is referred to as D90, and the maximum frequency diameter is referred to as Dmax.

The negative electrode sheet 40 includes a negative electrode current collector 42 and a negative electrode active material layer 44. The negative electrode current collector 42 is a member for holding the negative electrode active material layer 44 and supplying or collecting charges to the negative electrode active material layer 44. The negative electrode current collector 42 is electrochemically stable in the negative electrode environment in the battery, and a conductive member made of a metal (for example, copper, nickel, titanium, stainless steel, and the like) having good conductivity can be suitably used. In the embodiment, the negative electrode current collector 42 is, for example, a copper foil, and an unformed portion 42A having a constant width is set at one end portion in the width direction. The negative electrode active material layer 44 is formed on both surfaces of the negative electrode current collector 42 except for the unformed portion 42A. Here, the unformed portion 42A can be a negative electrode current collector of the electrode body 20.

The negative electrode active material layer 44 is a porous body containing negative electrode active material particles. The negative electrode active material layer 44 can be impregnated with an electrolyte. In the lithium ion secondary battery, the negative electrode active material particles are materials capable of absorbing lithium ions, which are charge carriers, at the time of charging and releasing at the time of discharging, like a lithium transition metal composite material. As the negative electrode active material particle, various materials used in the related art as the negative electrode active material of the lithium ion secondary battery can be used without particular limitation. Suitable examples include carbon materials such as artificial graphite, natural graphite, amorphous carbon and composites thereof (for example, amorphous carbon coated graphite), or materials forming an alloy with lithium such as silicon (Si), and lithium storage compounds such as lithium alloys (for example, LixM, M is C, Si, Sn, Sb, Al, Mg, Ti, Bi, Ge, Pb, or P, and X is a natural number.) and silicon compounds (SiO and the like).

The negative electrode sheet 40 can be produced, for example, by supplying the negative electrode paste to the surface of the negative electrode current collector 42 and then drying the negative electrode paste to remove the dispersion medium. The negative electrode paste is a mixture obtained by dispersing a powdery negative electrode active material and a binder (examples include styrene-butadiene copolymers (SBR), rubbers such as acrylic acid-modified SBR resins (SBR latex), and cellulosic polymers such as carboxymethylcellulose (CMC)) in an appropriate dispersion medium. Here, examples of the appropriate dispersion medium include water and N-methyl-2-pyrrolidone, preferably water.

An average particle diameter (D50) of the negative electrode active material particles is not particularly limited. The average particle diameter (D50) of the negative electrode active material particles may be, for example, 0.5 μm or more, preferably 1 μm or more, and more preferably 5 μm or more. In addition, the average particle diameter (D50) of the negative electrode active material particles may be 30 μm or less, preferably 20 μm or less, and more preferably 15 μm or less.

The proportion of the negative electrode active material to the whole negative electrode active material layer 44 is appropriately about 50 mass % or more, and is preferably from 90 mass % to 99 mass %, for example from 95 mass % to 99 mass %. When the binder is used, the proportion of the binder in the negative electrode active material layer 44 can be, for example, about 0.1 parts by mass to 5 parts by mass with respect to 100 parts by mass of the negative electrode active material, and the proportion is usually appropriate to be about 0.5 parts by mass to 2 parts by mass. The thickness (the thickness is an average thickness, and the same applies hereinafter.) of the negative electrode active material layer 44 may be, for example, 10 μm or more, typically 20 μm or more, and 80 μm or less, typically 50 μm or less. In addition, the density of the negative electrode active material layer 44 is not particularly limited, but may be, for example, 0.8 g/cm³ or more, typically 1.0 g/cm³ or more, and 1.5 g/cm³ or less, typically 1.4 g/cm³ or less, for example, 1.3 g/cm³ or less. The negative electrode active material layer 44 is a layer of negative electrode active material particles in which negative electrode active material particles are bonded with a binder. Microscopically, the negative electrode active material layer 44 has fine voids that can be impregnated with the non-aqueous electrolyte.

The separator sheets 51, 52 are components that insulate the positive electrode sheet 30 and the negative electrode sheet 40 and provide a moving route of the charge carrier between the positive electrode active material layer 34 and the negative electrode active material layer 44. The separator sheets 51, 52 are typically disposed between the positive electrode active material layer 34 and the negative electrode active material layer 44. The separator sheets 51, 52 may have a non-aqueous electrolyte holding function and a shutdown function of closing the moving route of the charge carrier at a predetermined temperature. The separator sheets 51, 52 are suitably configured with a microporous resin sheet consisting of a resin such as polyethylene (PE), polypropylene (PP), polyester, cellulose, polyamide or the like.

In a microporous sheet consisting of a polyolefin resin such as PE or PP, a shutdown temperature can be suitably set in the range of 80° C. to 140° C. (typically 110° C. to 140° C., for example, 120° C. to 135° C.). The shutdown temperature is a temperature at which the electrochemical reaction of the battery is stopped when the battery generates heat. The shutdown can be exhibited by, for example, melting or softening the separator sheets 51, 52. The separator sheets 51, 52 may have a single layer structure composed of a single material. In addition, the separator sheets 51, 52 may have a structure (for example, a three-layer structure in which PP layers are laminated on both surfaces of a PE layer) in which two or more kinds of microporous resin sheets having different materials and properties (for example, average thickness, porosity, or the like) are laminated.

The thickness (the thickness is an average thickness, and the same applies hereinafter.) of the separator sheets 51, 52 is not particularly limited, but may be generally 10 μm or more, typically 15 μm or more, for example, 17 μm or more. In addition, the upper limit can be 40 μm or less, typically 30 μm or less, for example, 25 μm or less. When the average thickness of the base material is within the above range, the permeability of the charge carriers can be kept good, and a minute short circuit (leakage current) is less likely to occur. Therefore, the input and output density and safety can be compatible at a high level.

As the non-aqueous electrolyte, typically, a solution in which a supporting salt (for example, a lithium salt, a sodium salt, a magnesium salt, or the like, and a lithium salt in a lithium ion secondary battery) as an electrolyte is dissolved or dispersed in a non-aqueous solvent can be used without any particular limitation.

As the non-aqueous solvent, various organic solvents such as carbonates, ethers, esters, nitriles, sulfones, and lactones used as an electrolyte in a general lithium ion secondary battery can be used without any particular limitation. Specific examples include chain carbonates such as diethyl carbonate (DEC), dimethyl carbonate (DMC), and ethyl methyl carbonate (EMC), and cyclic carbonates such as ethylene carbonate (EC) and propylene carbonate (PC). In addition, a solvent (for example, a cyclic carbonate) that is decomposed in the acidic atmosphere of the positive electrode to generate hydrogen ions may be partially included. The non-aqueous solvent may be fluorinated. Further, as the non-aqueous solvent, one kind can be used alone or two or more kinds can be used as a mixed solvent.

As the supporting salt, various salts used in a general lithium ion secondary battery can be appropriately selected and used. Examples include the use of lithium salts such as LiPF₆, LiBF₄, LiC₁O₄, LiAsF₆, Li (CF₃SO₂) ₂N, LiCF₃SO₃, and the like. The supporting salt may be used alone or in combination of two or more. The supporting salt may be prepared, for example, such that the concentration in the non-aqueous electrolyte falls within the range of 0.7 mol/L to 1.3 mol/L.

In addition, the non-aqueous electrolyte may contain various additives and the like as long as the characteristics of the secondary battery are not impaired. The additive may be used as a gas generating agent, a film forming agent, or the like for one or more purposes of improving the input and output characteristics of the battery, improving the cycle characteristics, and improving the initial charge and discharge efficiency. Specific examples of the additive include oxalato complex compounds such as fluorophosphate (preferably, the difluorophosphate is a difluorophosphate. For example, lithium difluorophosphate represented by LiPO₂F₂) and lithium bis (oxalato) borate (LiBOB). It is suitable that the concentration of the additives in the whole non-aqueous electrolyte is usually 0.1 mol/L or less (typically 0.005 mol/L to 0.1 mol/L).

It should be noted that the lithium ion secondary battery 1 shown in FIG. 1 uses a flat rectangular battery case as the battery case 10. However, the battery case 10 may be a non-flat rectangular battery case, a cylindrical battery case, a coin battery case, or the like. Alternatively, the lithium ion secondary battery 1 may be a laminated bag formed by bonding a metal battery case sheet (typically an aluminum sheet) and a resin sheet into a bag shape. In addition, for example, the battery case may be formed of aluminum, iron, alloys of these metals, high-strength plastic, or the like.

The lithium ion secondary battery 1 shown in FIG. 1 includes a so-called wound electrode body 20. In the wound electrode body 20 shown in FIG. 1, as shown in FIG. 2, a long positive electrode sheet 30 and a long negative electrode sheet 40 are superposed in a state of being insulated from each other by two separator sheets 51, 52, and wound around the winding axis WL. The width W1 of the positive electrode active material layer 34, the width W2 of the negative electrode active material layer 44, and the width W3 of the separator satisfy a relationship of W1<W2<W3. The positive electrode sheet 30, the negative electrode sheet 40, and two separator sheets 51, 52 are superposed such that the negative electrode active material layer 44 covers the positive electrode active material layer 34 and the separator sheets 51, 52 cover the negative electrode active material layer 44.

Here, as the electrode body 20 of the lithium ion secondary battery 1, a wound type electrode body is exemplified. Unless otherwise specified, the electrode body 20 is not limited to the wound type electrode body. Although not shown, the electrode body 20 may be, for example, a so-called flat plate laminated type electrode body in which a plurality of positive electrode sheets 30 and a plurality of negative electrode sheets 40 are laminated while being insulated by separator sheets 51, 52, respectively. In addition, the electrode body 20 may be a single cell in which one positive electrode sheet 30 and one negative electrode sheet 40 are accommodated in a battery case.

In the embodiment, the battery case 10 is configured with a case main body 11 and a lid 12, as shown in FIG. 1. The case main body 11 is a flat and substantially rectangular case with one surface open. The lid 12 is a member that is attached to the opening of the case main body 11 and closes the opening. The lid 12 may have a safety valve for discharging gas generated inside the battery case to the outside, a liquid injection port for injecting an electrolyte, or the like, as in the battery case of the lithium ion secondary battery of the related art. The lid 12 is provided with a positive electrode terminal 38 and a negative electrode terminal 48. The positive electrode terminal 38 and the negative electrode terminal 48 are insulated from the battery case 10, respectively. The positive electrode terminal 38 and the negative electrode terminal 48 have a positive electrode current collecting terminal 38a and a negative electrode current collecting terminal 48a respectively extending into the battery case 10. The positive electrode current collecting terminal 38a and a negative electrode current collecting terminal 48a are electrically connected to the positive electrode sheet 30 and the negative electrode sheet 40, respectively. The lithium ion secondary battery 1 is configured to be able to input and output electric power with an external device through the positive electrode terminal 38 and the negative electrode terminal 48.

The lithium ion secondary battery disclosed herein can be used for various purposes, but may have higher safety in repeated charging and discharging at a higher rate than conventional products, for example. In addition, the excellent battery performance and reliability (including safety such as thermal stability during overcharge) can be compatible at a high level. Therefore, by utilizing such characteristics, the lithium ion secondary battery is preferably used in applications requiring high energy density, high input and output density, and applications requiring high reliability. Examples of the applications as described above include a driving electric power source mounted on a vehicle such as a plug-in hybrid vehicle, a hybrid vehicle, and an electric vehicle. It should be noted that the secondary battery may be used in a form of an assembled battery in which a plurality of secondary batteries is typically connected at least one of in series or in parallel.

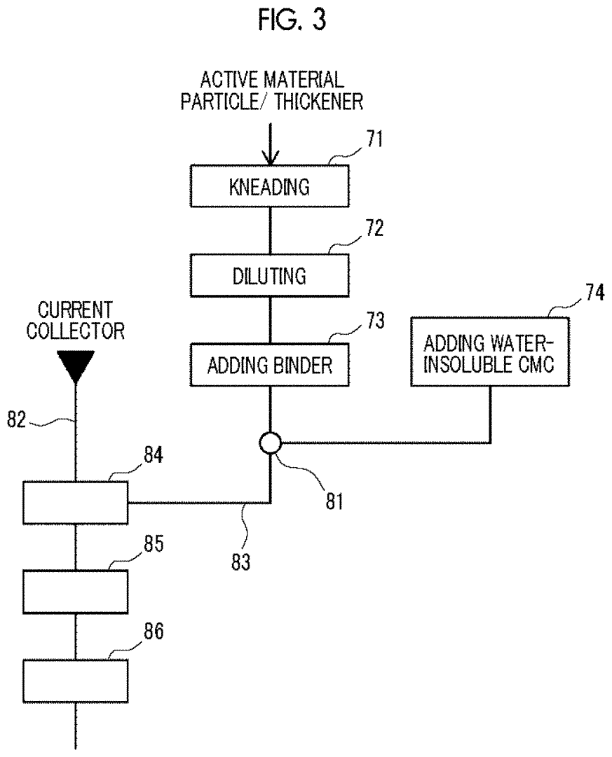

According to the method for manufacturing the non-aqueous electrolytic power storage device disclosed herein, a new active material layer structure for diffusing Li in the active material layer can be realized. Here, as one application example of the method for manufacturing the non-aqueous electrolytic power storage device, a method for manufacturing a non-aqueous electrolyte secondary battery will be exemplified. The method for manufacturing the non-aqueous electrolyte secondary battery described herein can be applied to a step of producing an electrode sheet such as the positive electrode sheet 30 or the negative electrode sheet 40. FIG. 3 is a process diagram schematically showing a step of producing an electrode sheet. The method for manufacturing the non-aqueous electrolyte secondary battery described herein can be appropriately applied to the same structure as other non-aqueous electrolytic power storage devices.

The method for manufacturing the non-aqueous electrolyte secondary battery disclosed herein includes, for example, a step of preparing a mixture paste in a step of producing the positive electrode sheet 30 or the negative electrode sheet 40, a step of applying the mixture paste to the current collector, and a step of drying the applied mixture paste.

In the step of preparing the mixture paste, the mixture paste obtained by mixing the active material particles, the binder, and carboxymethylcellulose in the aqueous solvent is prepared. When the positive electrode sheet 30 is manufactured, the mixture paste obtained by mixing the positive electrode active material particle, the binder, and carboxymethylcellulose in the aqueous solvent is prepared. When the negative electrode sheet 40 is manufactured, the mixture paste obtained by mixing the negative electrode active material particle, the binder, and carboxymethylcellulose in the aqueous solvent is prepared. The mixture paste prepared here may contain at least the active material particle, the binder, carboxymethylcellulose, and the aqueous solvent. A thickener, a dispersant, and the like may be appropriately added to the mixture paste. The thickener is a material that adjusts the viscosity of the mixture paste. The dispersant is a material that disperses the compounded materials.

The aqueous solvent is, for example, water (for example, ion-exchanged water, RO water, distilled water, and the like). Here, in terms of a solid content fraction in the mixture paste, the proportion of carboxymethylcellulose having an etherification degree of 40 (mol/C6) or less is preferably, for example, 0.5 wt % or more, and more preferably, 1 wt % or more. Carboxymethylcellulose having the etherification degree of 40 (mol/C6) or less can be classified as water-insoluble carboxymethylcellulose which is insoluble in water.

The carboxymethylcellulose contained in the mixture paste does not need to be all water-insoluble carboxymethylcellulose. The carboxymethylcellulose may contain not only the water-insoluble carboxymethylcellulose but also water-soluble carboxymethylcellulose. In terms of a solid content fraction in the mixture paste, the proportion of carboxymethylcellulose having the etherification degree of 40 (mol/C6) or less is preferably 15 wt % or less, more preferably 10 wt % or less. As a result, aggregation of the water-insoluble carboxymethylcellulose is suppressed, and a hole having an appropriate size is formed.

Carboxymethylcellulose is a derivative of cellulose in which a carboxymethyl group (—CH₂—COOH) is bonded to a part of hydroxy group of a glucopyranose monomer constituting a skeleton of cellulose. The carboxymethyl group is substituted by an ether bond with the alcoholic hydroxyl group of anhydrous glucose which is a constituent unit of cellulose. The degree of substitution (degree of substitution) as described above is referred to as the etherification degree. There are three alcoholic hydroxyl groups in each anhydrous glucose. Here, the etherification degree is evaluated by (mol/C6). The lower the etherification degree, the more likely it is that carboxymethylcellulose is insoluble in water.

It should be noted that the aqueous solvent may be a solvent that indicates the same performance as water for the water-insoluble carboxymethylcellulose. Therefore, the aqueous solvent may contain ion-exchanged water, RO water, distilled water, and the like.

The mixture paste is produced, for example, as shown in FIG. 3, by mixing the aqueous solvent, the active material particle, the binder, and carboxymethylcellulose in a predetermined mixture by a kneader 81. At this time, the mixture paste may appropriately contain a thickener and a dispersant.

It should be noted that in the step of preparing the mixture paste, the water-insoluble carboxymethylcellulose may be added last. For example, as shown in FIG. 3, the water-insoluble carboxymethylcellulose may be mixed after a kneading step 71, a diluting step 72, and a binder adding step 73. Here, in the kneading step 71, a mixture is obtained in which the active material particle, the thickener, and the like are mixed in a small amount of the aqueous solvent. Here, the thickener may contain water-soluble carboxymethylcellulose. In the diluting step 72, the aqueous solvent is added to the kneaded mixture. In the binder adding step 73, the binder is added to the diluted mixture. The water-insoluble carboxymethylcellulose may be mixed in the diluted mixture.

For example, when the active material particle is a graphite particle, assuming that the water-insoluble carboxymethylcellulose is added in the kneading step, the water-insoluble carboxymethylcellulose may adhere to the graphite surface and reduce a reaction area on a graphite surface. In addition, the kneading time of the water-insoluble carboxymethylcellulose is reduced by mixing the water-insoluble carboxymethylcellulose after the other materials of the mixture paste are mixed. Therefore, the water-insoluble carboxymethylcellulose is prevented from being loosened by the kneading. That is, the water-insoluble carboxymethylcellulose is not loosened and remains as large gel particles. As a result, a large number of large pores of 40 μm or more are formed.

As described above, in the step of preparing the mixture paste, the mixture paste in which the active material particle and the binder are mixed in the aqueous solvent is prepared, and the step of mixing carboxymethylcellulose having an etherification degree of 40 (mol/C6) or less may be included in the mixture paste. In other words, in the step of preparing the mixture paste, the water-insoluble carboxymethylcellulose may be added last. When the water-insoluble carboxymethylcellulose is added last, in the prepared mixture paste, the water-insoluble carboxymethylcellulose hardly reduces the reaction area on the surface of the active material particle, and the water-insoluble carboxymethylcellulose remains in the mixture paste in the state of a large gel particle.

In the step of applying the mixture paste to the current collector, the prepared mixture paste is applied to the current collector as shown in FIG. 3. Here, the current collector is, for example, a strip-shaped current collector foil, and is transported by a transport apparatus 82. The mixture paste kneaded by the kneader 81 is supplied to a die 84 through a supply pipe 83. A discharge port of the die 84 is directed to the current collector transported by the transport apparatus 82. The mixture paste discharged from the die 84 is applied onto the current collector transported by the transport apparatus 82. For example, when the positive electrode sheet 30 is manufactured, the mixture paste containing the positive electrode active material particle may be applied to the positive electrode current collector 32 in a predetermined basis weight. When the negative electrode sheet 40 is manufactured, the mixture paste containing the negative electrode active material particle may be applied to the negative electrode current collector 42 in a predetermined basis weight.

In the step of drying the mixture paste, for example, the current collector applied with the mixture paste may be disposed in a drying furnace 85 set to a predetermined drying atmosphere to dry the mixture paste. As a result, an active material layer is formed on the current collector. Thereafter, the current collector having the active material layer formed thereon is appropriately passed through the press 86 to adjust the active material layer to an appropriate thickness.

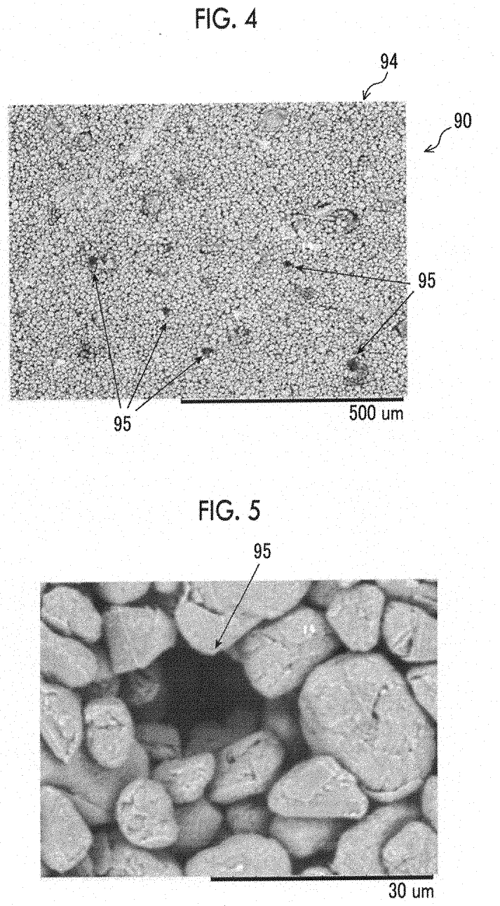

FIG. 4 is an SEM photograph of a surface of an active material layer. In the electrode sheet 90 formed in this way, as shown in FIG. 4, many holes 95 recessed in an active material layer 94 are formed on the surface of the active material layer 94. The holes 95 are significantly larger than the pores due to the voids between the normal active material particles of the active material layer 94. In addition, the holes 95 are formed by being appropriately dispersed on the surface of the active material layer 94. FIG. 5 is an SEM photograph in which the holes 95 on the surface of the active material layer are enlarged. It should be noted that each of the above photographs shows one example of the holes 95.

It should be noted that the carboxymethylcellulose used as the thickener may contain a small amount of the water-insoluble carboxymethylcellulose. When the water-insoluble carboxymethylcellulose is contained, such holes 95 may be formed in the active material layer 94. However, the holes 95 are not properly dispersed and formed on the surface of the active material layer 94 unless a certain amount or more of the water-insoluble carboxymethylcellulose is contained. From the viewpoint of reducing the resistance, it is desirable that the holes 95 are properly dispersed and formed. From the viewpoint as described above, the mixture paste needs to contain the water-insoluble carboxymethylcellulose in a certain amount or more. For example, the proportion of the water-insoluble carboxymethylcellulose having an etherification degree of 40 (mol/C6) or less in the carboxymethylcellulose contained in the active material layer 94 is preferably 50% or more. Here, the water-insoluble carboxymethylcellulose may be prepared when adjusting a mixture paste 96. The etherification degree and the proportion of the water-insoluble carboxymethylcellulose can be obtained by designating the material manufacturer when preparing carboxymethylcellulose (CMC). Such carboxymethylcellulose is available, for example, from Nippon Paper Industries Co., Ltd. In addition, for example, as a commercially available material, SLD-F1, SLD-FM manufactured by Nippon Paper Industries Co., Ltd. can be used.

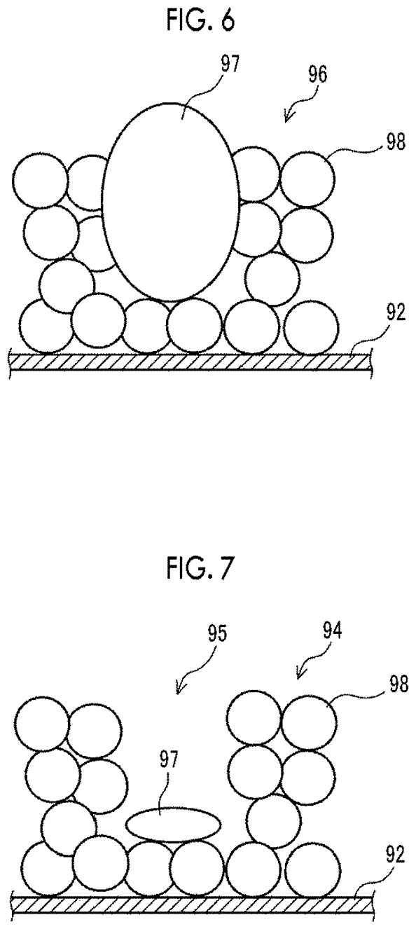

FIG. 6 is a cross-sectional view schematically showing the current collector 92 applied with the mixture paste 96. FIG. 7 is a cross-sectional view schematically showing the current collector 92 in a state where the mixture paste 96 is dried. As described above, the water-insoluble carboxymethylcellulose 97 is dispersed in the mixture paste 96 applied to the current collector at a certain proportion or more. As shown in FIG. 6, the water-insoluble carboxymethylcellulose 97 contains the aqueous solvent and is swollen. Therefore, the water-insoluble carboxymethylcellulose 97 has a volume significantly larger than a volume of active material particles 98.

In the drying step, as shown in FIG. 7, the aqueous solvent in the mixture paste 96 disappears. The aqueous solvent contained in the gap between the active material particles 98 in the mixture paste 96 is easily dried. On the other hand, the aqueous solvent contained in the water-insoluble carboxymethylcellulose 97 is slowly dried. Therefore, a layer of the active material particles 98 is formed around the water-insoluble carboxymethylcellulose 97 by drying. In addition, the aqueous solvent contained in the water-insoluble carboxymethylcellulose 97 gradually disappears. The water-insoluble carboxymethylcellulose 97 withers in the process of disappearance of the aqueous solvent.

Therefore, the holes 95 are formed where the water-insoluble carboxymethylcellulose 97 is swollen and present in the mixture paste 96 applied to the current collector 92. On the other hand, the water-insoluble carboxymethylcellulose 97 is adsorbed to the active material particles 98 and therefore remains in the holes 95 even after being withered. The holes 95 formed in this way are partially exposed on the surface of the active material layer 94. In the lithium ion secondary battery 1, the electrolyte is injected into the battery case 10 (refer to FIG. 1). The water-insoluble carboxymethylcellulose 97 swells in an aqueous solvent, but does not similarly swell in the non-aqueous solvent which is a solvent of the electrolyte. Therefore, in the lithium ion secondary battery 1 (refer to FIG. 1), the active material layer 94 exists in the withered state in the holes 95. A large number of holes 95 due to the water-insoluble carboxymethylcellulose 97 are dispersed and formed on the surface of the active material layer 94.

The holes 95 due to the water-insoluble carboxymethylcellulose 97 has a size close to a size when the water-insoluble carboxymethylcellulose 97 swelled in the mixture paste 96. The size of the holes 95 can be measured and extracted as holes 95 having a size of 4 μm or more and 106 μm or less per unit area by measurement with mercury porosimeter, for example. The holes 95 are distinguished from the pores between the active material particles 98 in the active material layer 94 in the size as described above. For clearer distinction, the size may be measured as holes of 10 μm or more, further 15 μm or more. In addition, for example, the holes 95 larger than half the average particle diameter (D50) of the active material particles 98 used for the active material layer 94 may be measured and extracted.

As a result, for example, the active material layer 94 having pores of 4 or more and 106 μm or less per unit area and 25% or more of the total pore volume can be formed. The proportion of pores of 4 μm or more and 106 μm or less to the total pore volume can be measured by measuring the electrode sheet 90 with mercury porosimeter, for example. When the water-insoluble carboxymethylcellulose 97 is not contained in the mixture paste 96 in a certain proportion or more as described above, in the active material layer 94 obtained by drying the mixture paste, the holes 95 of 4 μm or more and 106 μm or less per unit area as described above do not constitute a large proportion of 25% or more of the total pore volume. In particular, when the average particle diameter (D50) of the active material particles is 50 μm or less (for example, 30 μm or less), the above-described holes 95 due to the water-insoluble carboxymethylcellulose 97 are not formed by 25% or more of the total pore volume.

For example, the average particle diameter (D50) of the positive electrode active material particles is, for example, about 1 μm or more and 15 μm or less. Therefore, when such positive electrode active material particles are used, pores of 4 μm or more and 106 μm or less per unit area in the positive electrode active material layer 34 are not formed much in the first place. In addition, the average particle diameter (D50) of the negative electrode active material particles is, for example, 0.5 μm or more and 30 μm or less. Even when the negative electrode active material particles are used, pores of 4 μm or more and 106 μm or less per unit area are not formed in the negative electrode active material layer 44 at the proportion of 25% or more of the total pore volume.

When the electrode sheet described herein is used for either the positive electrode sheet 30 or the negative electrode sheet 40, the electrolyte is impregnated into the active material layer 94 by capillary action. At this time, since the holes 95 are significantly larger than the pores due to the voids between the active material particles, the electrolyte can easily enter. The holes 95 are connected to the pores due to the voids between the active material particles. For this reason, a migration distance of lithium is shortened inside the active material layer, and uneven concentration of Li salt is less likely to occur. The holes 95 are likely to be an inlet through which the active material layer 94 is impregnated with the electrolyte, since the electrolyte easily enters the active material layer 94. Then, the holes 95 are dispersed and formed on the surface of the active material layer 94. For this reason, the electrolyte is easily impregnated in the entire active material layer 94. Therefore, in the non-aqueous electrolyte secondary battery manufactured by the manufacturing method described herein, the active material layer is likely to be impregnated with the electrolyte and Li is likely to diffuse. Therefore, the resistance can be reduced.

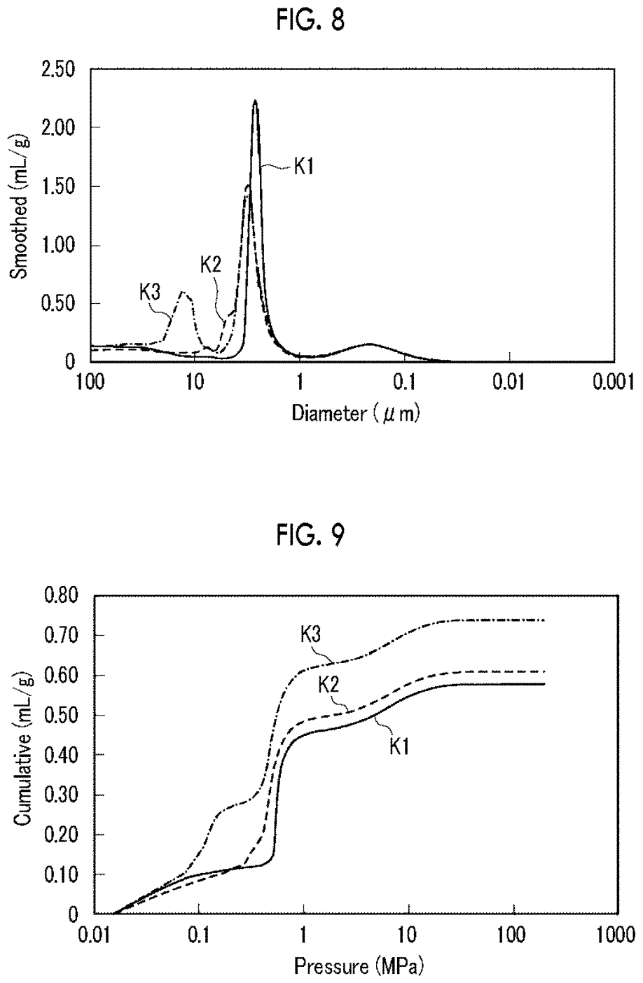

FIG. 8 and FIG. 9 are a graph showing measurement results of mercury porosimeter of an active material layer. FIG. 8 shows a pore diameter distribution of the active material layer. FIG. 9 shows the pore diameter distribution of the active material layer 94.

Here, graphite as an active material particle, a styrene-butadiene copolymer (SBR) as a binder, and carboxymethylcellulose (CMC) as a thickener are kneaded in ion-exchanged water to prepare the mixture paste for forming the negative electrode active material layer. This mixture paste is applied to both surfaces of a copper foil (negative electrode current collector), dried, and roll-pressed. Here, the thickness of the active material layer 94 is 40 μm, and the weight per unit area is 5 mg/cm².

Here, an active material layer K1 which does not contain the water-insoluble carboxymethylcellulose, an active material layer K2 in which the proportion of the water-insoluble carboxymethylcellulose is 0.2 wt %, and an active material layer K3 in which the proportion of the water-insoluble carboxymethylcellulose is 0.5 wt % are prepared. FIG. 8 and FIG. 9 are graphs showing the measurement results of the mercury porosimeters of the active material layers K1, K2 and K3 prepared here.

As shown in FIG. 8, each of the active material layers K1, K2, and K3 prepared here has a peak of pore diameter distribution at a position smaller than 4 μm. The peaks are caused by the pores between the active material particles. In the active material layer K3 in which the proportion of the water-insoluble carboxymethylcellulose is 0.5 wt % as compared with the active material layers K1 and K2 in which the proportion of the water-insoluble carboxymethylcellulose is small, another peak of the pore diameter distribution is formed in the range of 4 μm to 106 μm apart from the peak due to the pores between the active material particles. It is considered that the peak of the pore diameter distribution in the range of 4 μm to 106 μm is formed due to the holes 95 (refer to FIG. 4 and FIG. 7) formed after the water-insoluble carboxymethylcellulose has withered in the drying step. In addition, in the active material layer K3 in which the proportion of the water-insoluble carboxymethylcellulose is 0.5 wt % due to the holes 95 (refer to FIG. 4 and FIG. 7) formed after the water-insoluble carboxymethylcellulose has withered, as shown in FIG. 9, there is a part where the pore volume increases as the pressure of the mercury porosimeter decreases. As described above, it is considered that the holes that are significantly larger than the pores between normal active material particles are dispersed and formed in a certain amount due to the holes 95 formed after the water-insoluble carboxymethylcellulose has withered.

Construction of Non-aqueous Electrolyte Secondary Battery

A test battery is constructed by respectively changing the addition amounts of the water-insoluble carboxymethylcellulose contained in the positive electrode active material layer 34 and the negative electrode active material layer 44 (refer to FIG. 2).

Here, LiNi_{1/3}Co_{1/3}Mn_{1/3}O₂ as a positive electrode active material, acetylene black as a conductive material, and a binder are kneaded in a paste solvent to prepare the paste for forming the positive electrode active material layer. The paste is applied to both surfaces of an aluminum foil (positive electrode current collector), dried and roll-pressed to produce a positive electrode having the positive electrode active material layer on the positive electrode current collector. Here, when the paste for forming the positive electrode active material layer is prepared by using a non-aqueous solvent, for example, N-methylpyrrolidone (NMP) is used as the paste solvent, and PolyVinylidene DiFluoride (PVDF) is used as the binder. On the other hand, when the paste for forming the positive electrode active material layer is prepared by using the aqueous solvent, polytetrafluoroethylene (PTFE), sodium polyacrylate, or styrene acrylic acid may be used as the binder. Here, in order to compare the case where the water-insoluble carboxymethylcellulose is used, the aqueous solvent is used to prepare the paste for forming the positive electrode active material layer, and styrene acrylic acid is used as the binder.

Next, graphite as a negative electrode active material, a styrene-butadiene copolymer (SBR) as a binder, and carboxymethylcellulose (CMC) as a thickener are kneaded in ion-exchanged water to prepare the paste for forming the negative electrode active material layer. The paste is applied to both surfaces of a copper foil (negative electrode current collector), dried and roll-pressed to produce a negative electrode having the negative electrode active material layer on the negative electrode current collector.

In the step of preparing the paste for forming the positive electrode active material layer or the paste for forming the negative electrode active material layer, the water-insoluble carboxymethylcellulose (SLD-FM manufactured by Nippon Paper Industries Co., Ltd.) is finally added to each test battery. The addition amount of the water-insoluble carboxymethylcellulose is adjusted to a predetermined proportion in the paste. In other respects, unless otherwise stated, the paste for forming the positive electrode active material layer or the paste for forming the negative electrode active material layer do not intentionally include the water-insoluble carboxymethylcellulose.

Next, a separator consisting of a polyethylene (PE) porous base material is used as a separator. The separator is sandwiched between the positive electrode and the negative electrode produced above to prepare an electrode body. In addition, a non-aqueous electrolyte is prepared by dissolving LiPF₆ as a support salt at a concentration of 1 mol/L in a mixed solvent containing ethylene carbonate (EC), dimethyl carbonate (DMC), and ethylmethyl carbonate (EMC) at a volume ratio of 3:4:3.

Then, a battery case made of laminate is inserted after lead terminals are respectively welded to the positive and negative electrodes of the electrode body, and the prepared non-aqueous electrolyte solution is injected to construct a lithium ion secondary battery (battery capacity 15 mAh).

Aging

After the non-aqueous electrolyte is injected, the battery which has been used for 10 hours is charged to state of charge (SOC) of 80% and then stored at 60° C. for 20 hours.

Measurement of Diffusion Resistance of Li

In the measurement the diffusion resistance of Li, uncharged electrodes (negative electrode and negative electrode) or (positive electrode and positive electrode) are superposed and AC impedance measurement is performed to obtain a Cole-Cole plot. The Cole-Cole plot obtained here is fitted with resistance (R) and diffusion resistance (Wo) to obtain an ion diffusion resistance of the uncharged electrode. Here, the ion diffusion resistance of each electrode is evaluated by setting the ion diffusion resistance of the electrode to which the water-insoluble carboxymethylcellulose is not added as 100.

Initial Resistance Measurement

Under a temperature condition of 25° C., the battery is adjusted to a state of SOC of 60%, a constant current charge and a constant current discharge are performed for 10 seconds at 15 mA, and the initial resistance is obtained from the voltage rise and voltage drop at this time. Here, the resistance obtained during charging is adopted as the initial resistance.

Capacity Test

After the aging, the capacity of the battery is measured. Here, the battery is adjusted to 4.1V by CCCV charging, and then discharged to 3.1V by a predetermined

CCCV discharge. The battery capacity is determined by the amount of electricity discharged at that time. After the battery is adjusted to SOC 80%, the battery is charged for 5 seconds and discharged for 5 seconds with a predetermined current value of 100 A to 150 A as one cycle, repeated a predetermined number of times (here, 1000 cycles), and the battery capacity is measured again after the cycle test. A value obtained by dividing the battery capacity after the cycle test by the battery capacity before the cycle test is defined as a capacity retention rate.

High Rate Cycle Test

A high rate cycle test is performed on the battery after the measurement of the initial resistance. In the high rate cycle test here, charging and discharging are performed with a predetermined pulse current. Here, for example, in a vehicle application, a pulse current that can be generated under conditions that simulate the movement of an accelerator pedal on an expressway may be prepared for a high rate cycle test.

The test results as described above are summarized in Table 1.

TABLE 1

| | Addition | | | | | | Proportion of |
|---|---|---|---|---|---|---|---|
| | amount of water- | Etherification | | Li diffusion | High rate | Capacity | 4 μm to 106 |
| | insoluble CMC | degree | Active material | resistance | durability | retention rate | μm to total |
| | (wt %) | (mol/C6) | layer | (%) | (%) | (%) | pore volume |
| Sample 1 | 0.5 | 40 | Negative | 92 | 140 | 106 | 25 |
| | | | electrode active | | | | |
| | | | material layer | | | | |
| Sample 2 | 0.4 | 40 | Negative | 100 | 101 | 99 | 23 |
| | | | electrode active | | | | |
| | | | material layer | | | | |
| Sample 3 | 0.5 | 42 | Negative | 99 | 98 | 97 | 21 |
| | | | electrode active | | | | |
| | | | material layer | | | | |
| Sample 4 | 2 | 42 | Negative | 101 | 94 | 95 | 23 |
| | | | electrode active | | | | |
| | | | material layer | | | | |
| Sample 5 | 2 | 40 | Negative | 84 | 250 | 117 | 41 |
| | | | electrode active | | | | |
| | | | material layer | | | | |
| Sample 6 | 0.5 | 40 | Positive | 96 | 110 | 102 | 26 |
| | | | electrode active | | | | |
| | | | material layer | | | | |
| Sample 7 | 0 | — | Negative | 100 | 100 | 100 | 19 |
| | | | electrode active | | | | |
| | | | material layer | | | | |
| Sample 8 | 0 | — | Positive | 100 | 100 | 100 | 1 |
| | | | electrode active | | | | |
| | | | material layer | | | | |

In Table 1, each sample is one in which the water-insoluble carboxymethylcellulose is added to the mixture paste when the active material layer indicated by the active material layer is produced. The addition amount (solid content fraction in the mixture paste) of the water-insoluble carboxymethylcellulose (CMC) and the etherification degree of the added the water-insoluble carboxymethylcellulose are shown in Table 1, respectively.

Sample 7 is one in which the water-insoluble carboxymethylcellulose is not added to the paste for forming the negative electrode active material layer when forming the negative electrode active material layer. Sample 8 is one in which the water-insoluble carboxymethylcellulose is not added to the paste for forming the positive electrode active material layer when forming the positive electrode active material layer.

Sample 1 is one in which 0.5 wt % of the water-insoluble carboxymethylcellulose is added to the paste for forming the negative electrode active material layer when forming the negative electrode active material layer. Here, the etherification degree of the water-insoluble carboxymethylcellulose is set to 40 (mol/C6). In other respects, the same configuration as the configuration of sample 7 is adopted.

Sample 2 is one in which 0.4 wt % of the water-insoluble carboxymethylcellulose is added to the paste for forming the negative electrode active material layer when forming the negative electrode active material layer. Here, the etherification degree of the water-insoluble carboxymethylcellulose is set to 40 (mol/C6).

In other respects, the same configuration as the configuration of sample 7 is adopted.

Sample 3 is one in which 0.5 wt % of the water-insoluble carboxymethylcellulose is added to the paste for forming the negative electrode active material layer when forming the negative electrode active material layer. Here, the etherification degree of the water-insoluble carboxymethylcellulose is set to 42 (mol/C6).

In other respects, the same configuration as the configuration of sample 7 is adopted.

Sample 4 is one in which 2 wt % of the water-insoluble carboxymethylcellulose is added to the paste for forming the negative electrode active material layer when forming the negative electrode active material layer. Here, the etherification degree of the water-insoluble carboxymethylcellulose is set to 42 (mol/C6).

In other respects, the same configuration as the configuration of sample 7 is adopted.

Sample 5 is one in which 2 wt % of the water-insoluble carboxymethylcellulose is added to the paste for forming the negative electrode active material layer when forming the negative electrode active material layer. Here, the etherification degree of the water-insoluble carboxymethylcellulose is set to 40 (mol/C6).

In other respects, the same configuration as the configuration of sample 7 is adopted.

Sample 6 is one in which 0.5 wt % of the water-insoluble carboxymethylcellulose is added to the paste for forming the positive electrode active material layer when forming the positive electrode active material layer. Here, the etherification degree of the water-insoluble carboxymethylcellulose is set to 40 (mol/C6).

In other respects, the same configuration as the configuration of sample 8 is adopted.

The Li diffusion resistance (%) is the Li diffusion resistance of the active material layer indicated by the active material layer, and samples 7, 8 in which the water-insoluble carboxymethylcellulose is not added to the active material layer are evaluated as 100, respectively. The method for measuring the Li diffusion resistance (%) is as described above.

A total pore volume proportion (%) of 4 μm to 106 μm is a volume proportion of the pore diameter of 4 μm to 106 μm with respect to the total pore volume, and is a value measured by the mercury porosimeter for the active material layer indicated by the active material layer.

In Table 1, the high rate durability (%) is evaluated by the number of cycles until the resistance value became 1.06 times the initial resistance in the above-described high rate cycle test. The high rate durability (%) is evaluated by setting samples 7, 8 in which the water-insoluble carboxymethylcellulose is not added to the active material layer to 100, respectively. In addition, the capacity retention rate (%) is relatively evaluated based on the results of the capacity test described above, assuming that the capacity retention rate of samples 7, 8 to which the water-insoluble carboxymethylcellulose is not added to the active material layer is 100.

Here, in samples 1 to 5, in the step of forming the negative electrode active material layer, the water-insoluble carboxymethylcellulose is mixed in the paste for forming the negative electrode active material layer. For the test battery used in the high rate cycle test and the capacity test, respectively, the positive electrode sheet of sample 8 in which water-insoluble carboxymethylcellulose is not mixed is used. In sample 6, in the step of forming the positive electrode active material layer, the water-insoluble carboxymethylcellulose is mixed in the paste for forming the positive electrode active material layer. For the test battery, the negative electrode sheet of sample 7 in which water-insoluble carboxymethylcellulose is not mixed is used. Samples 7, 8 are not mixed with the water-insoluble carboxymethylcellulose, respectively. Samples 7, 8 are combined with each other to produce the test battery.

As shown in Table 1, sample 1 is improved from sample 7 in terms of Li diffusion resistance, high rate durability, and capacity retention rate. That is, when the negative electrode active material layer is formed, carboxymethylcellulose having the etherification degree of 40 (mol/C6) is mixed in the paste for forming the negative electrode active material layer at a proportion of 0.5 wt %, which is considered to contribute. On the other hand, as shown in sample 2, when the proportion of carboxymethylcellulose having the etherification degree of 40 (mol/C6) is 0.4 wt %, significant improvement is not observed in terms of Li diffusion resistance, high rate durability and capacity retention rate. In addition, as shown in sample 5, when the proportion of carboxymethylcellulose having the etherification degree of 40 (mol/C6) is 2 wt %, all of the components are remarkably improved in terms of Li diffusion resistance, high rate durability, and capacity retention rate. In addition, as shown in samples 3, 4, when carboxymethylcellulose having an etherification degree of 42 (mol/C6) is mixed, improvement is not observed in terms of Li diffusion resistance, high rate durability, and capacity retention rate. The lower the etherification degree, the more water insoluble it becomes.

In addition, sample 6 is improved from sample 8 in terms of Li diffusion resistance, high rate durability, and capacity retention rate. That is, when the positive electrode active material layer is formed, carboxymethylcellulose having the etherification degree of 40 (mol/C6) is mixed in the paste for forming the positive electrode active material layer at a proportion of 0.5 wt %, which is considered to contribute. In the process of forming the positive electrode active material layer, the holes 95 are formed after the water-insoluble carboxymethylcellulose contained in the paste for forming the positive electrode active material layer is withered similarly in the positive electrode active material layer and the negative electrode active material layer. Therefore, it is considered that the positive electrode shows the same tendency as the negative electrode. Therefore, when the proportion of carboxymethylcellulose having the etherification degree of 40 (mol/C6) or less is 0.5 wt % or more in terms of a solid content fraction in the mixture paste, it can be expected that the Li diffusion resistance, the high rate durability, and the capacity retention rate are all improved.

In the example shown in Table 1, in the step of preparing the paste for forming the positive electrode active material layer or the paste for forming the negative electrode active material layer, the water-insoluble carboxymethylcellulose is added last. Table 2 shows a test for evaluating the timing of adding the water-insoluble carboxymethylcellulose in the step of preparing the paste for forming the negative electrode active material layer. In sample 21 of Table 2, the water-insoluble carboxymethylcellulose is added in the kneading step in the step of preparing the paste for forming the negative electrode active material layer. In sample 22, the water-insoluble carboxymethylcellulose is added after the binder adding step in the step of preparing the paste for forming the negative electrode active material layer. In sample 23, the water-insoluble carboxymethylcellulose is not added in the step of preparing the paste for forming the negative electrode active material layer. In other respects, samples 21 to 23 are set to the same configuration. For example, sample 21 and sample 22 are set to the same addition amount of the water-insoluble carboxymethylcellulose and the same etherification degree of water-insoluble carboxymethylcellulose. Here, the etherification degree of the water-insoluble carboxymethylcellulose is set to 40 (mol/C6).

TABLE 2

| | | Initial | Pore volume of |
|---|---|---|---|
| | Timing | resistance | 40 μm or more |
| Sample 21 | Add In kneading step | 131 | 52 |
| Sample 22 | Add after binder adding step | 87 | 100 |
| Sample 23 | No addition | 100 | 0 |

As shown in Table 2, when the water-insoluble carboxymethylcellulose is added during the kneading step, the initial resistance of the test battery may be greater than when water-insoluble carboxymethylcellulose is not added. In addition, the pore volume of 40 μm or more in the active material layer is larger when the water-insoluble carboxymethylcellulose is added last than when the water-insoluble carboxymethylcellulose is added in the kneading step. Therefore, when the water-insoluble carboxymethylcellulose is added from the viewpoint of reducing the resistance as described above, the water-insoluble carboxymethylcellulose may be added last in the step of preparing the paste for forming the positive electrode active material layer or the paste for forming the negative electrode active material layer.

The non-aqueous electrolyte secondary battery or electrode sheet described herein may contain carboxymethylcellulose (water-Insoluble carboxymethylcellulose) having the etherification degree of 40 (mol/C6) or less as described above. As a result, the active material layer 94 having pores of 4 μm or more and 106 μm or less per unit area and 25% or more of the total pore volume may be provided. In this case, as described above, the electrolyte is easily impregnated into the active material layer of the non-aqueous electrolyte secondary battery, and Li is easily diffused. Therefore, the resistance of the non-aqueous electrolyte secondary battery can be reduced.

In the non-aqueous electrolyte secondary battery or electrode sheet described herein, for example, the proportion of carboxymethylcellulose having the etherification degree of 40 (mol/C6) or less contained in the active material layer 94 may be 0.5 wt % or more. In this case, the active material layer 94 formed by dispersing a large number of holes 95 due to water-insoluble carboxymethylcellulose is stably obtained. In addition, when the water-insoluble carboxymethylcellulose is added too much, the battery resistance may increase. From the above viewpoint, the proportion of carboxymethylcellulose having the etherification degree of 40 (mol/C6) or less contained in the active material layer 94 may be, for example, 2 wt % or less.

In the non-aqueous electrolyte secondary battery or electrode sheet described herein, for example, the proportion of carboxymethylcellulose having the etherification degree of 40 (mol/C6) or less in the carboxymethylcellulose contained in the active material layer 94 may be 50% or more. In this case, the active material layer 94 formed by dispersing a large number of holes 95 due to water-insoluble carboxymethylcellulose is stably obtained.

The non-aqueous electrolytic power storage device and the method for manufacturing the non-aqueous electrolytic power storage device described herein have been variously described with reference to the non-aqueous electrolyte secondary battery (specifically, a lithium ion secondary battery). Unless otherwise stated, the embodiments of the non-aqueous electrolytic power storage device and the method for manufacturing the non-aqueous electrolytic power storage device described herein are not limited to the present disclosure.

For example, the electrode sheet and the method for manufacturing the electrode sheet described herein can be widely applied to the electrode sheet of the non-aqueous electrolytic power storage device in which a layer of active material particles is formed on the current collector, such as the negative electrode sheet of the lithium ion capacitor. According to the method described herein, the active material layer 94 (refer to FIGS. 4 and 5) formed by dispersing a large number of holes 95 due to the water-insoluble carboxymethylcellulose can be stably obtained.

What is claimed is:

1. A method for manufacturing a non-aqueous electrolytic power storage device, the method comprising:
preparing a mixture paste in which an active material particle, a binder, and carboxymethylcellulose are mixed in an aqueous solvent;
applying the mixture paste to a current collector; and
drying the mixture paste that is applied to the current collector,
wherein a proportion of carboxymethylcellulose having an etherification degree of 40 mol/C6 or less is 0.5 wt % or more in terms of a solid content fraction in the mixture paste.

2. The method for manufacturing the non-aqueous electrolytic power storage device according to claim 1, wherein the proportion of carboxymethylcellulose having the etherification degree of 40 mol/C6 or less is 15 wt % or less in terms of the solid content fraction in the mixture paste.

3. The method for manufacturing the non-aqueous electrolyte power storage device according to claim 1, wherein the preparing of the mixture paste includes preparing the mixture paste in which the active material particle and the binder are mixed in the aqueous solvent, and then mixing carboxymethylcellulose having the etherification degree of 40 mol/C6 or less into the mixture paste.

4. Anon-aqueous electrolytic power storage device comprising an active material layer that contains carboxymethylcellulose having an etherification degree of 40 mol/C6 or less and has pores of 4 μm or more and 106 μm or less per unit area, the pores having 25% or more of a total pore volume.

5. The non-aqueous electrolytic power storage device according to claim 4, wherein a proportion of carboxymethylcellulose having the etherification degree of 40 mol/C6 or less, contained in the active material layer is 0.5 wt % or more.

6. The non-aqueous electrolytic power storage device according to claim 4, wherein a proportion of carboxymethylcellulose having the etherification degree of 40 mol/C6 or less, contained in the active material layer is 2 wt % or less.

7. The non-aqueous electrolytic power storage device according to claim 4, wherein a proportion of carboxymethylcellulose having the etherification degree of 40 mol/C6 or less in the carboxymethylcellulose contained in the active material layer is 50% or more.
